(19) United States
(12) Patent Application Publication
(10) Pub. No.: US 2019/0386488 A1
(43) Pub. Date: Dec. 19, 2019

(54) Creating a Note Receivable or Receivables from an Equity Investment Using a Risk Shifting Method for Investments in Wind Power Generation

(71) Applicant: Jupiter Renewables, LLC, Armonk, NY (US)

(72) Inventor: David E. Freund, Armonk, NY (US)

(21) Appl. No.: 16/440,965

(22) Filed: Jun. 13, 2019

Related U.S. Application Data
(60) Provisional application No. 62/684,462, filed on Jun. 13, 2018.

(51) Int. Cl. H02J 3/00; G06Q 40/06; G06Q 40/08

(52) U.S. Cl. CPC H02J 3/008; G06Q 40/08; G06Q 40/06

(57) ABSTRACT

Treatment of an investment in a power generation project as Equity Linked Notes is performed shifting at least a portion of the risk of the wind power generation project investment from an investor to a guarantor(s). An investor pays a premium amount for a wind power generation project with a guaranteed total return floor amount for the wind power generation project, having an amount of a fixed payment associated with the wind power generation project and an amount of a variable payment associated with the wind power generation project. Risks for operating conditions, equipment, and residual value are mitigated with contractual risk mitigants and the investor obtains a service provider and an asset manager for the power generation project in a manner that preserves the investors position as the owner/operator.

### CROSS REFERENCE TO RELATED APPLICATIONS

This application claims the benefit of U.S. Provisional Application No. 62/684,462, filed Jun. 13, 2019, which is incorporated by reference in its entirety.

### BACKGROUND

### Field of the Invention

This disclosure relates generally to systems and methods that provide mechanisms for renewable energy power generation investors to shift their risk in an investment to another entity and in some circumstances may maintain qualification for production tax credits under the United States tax code. For the purposes of the invention, the tax credits may be treated as operating revenue, and the disclosure may generally relate to renewable energy power generation and is applicable to projects that are and are not eligible for such tax benefits. More particularly, this disclosure relates to systems and method that provide mechanisms for an investor in a wind power generation project to shift the risk in the investment to a guarantor(s), while maintaining the role of owner and operator of the wind power generation project. In particular, this disclosure relates to systems and methods for transforming an equity investment into a series of Notes Receivables where the Notes that are backed by fixed and determinable payments that may be treated as Equity Linked Notes and permit the investor to use interest method financial accounting. The method relies on a unique combination of steps that do not exist in any text book or literature prior to this invention and invent a new derivative that does not exist in the prior art: the ability for an equity investor in a variable renewable power generation project to structure their investment so that it meets all of the criteria to be considered debt. These requirements to be treated as debt have been tested by the courts in cases involving the National Bank Act, and this method allows the investor to meet all of the requirements. See M & M Leasing Corp. v. Seattle First Nat'l Bank, 563 F.2d 1377 (9th Cir. 1977). There is a need for this invention as the current art for financing renewable power generation does not meet all of the criteria of the above case precedent. While the Office of the Comptroller of the Currency, which is a political entity within the United States Treasury Department, has permitted loan treatment under certain conditions, these conditions may not be considered to not meet the requirements of the courts. This disclosure provides investors with a method that meets the court requirements that a lease is a debt investment because it provides the investor with a fixed and determinable schedule of principal and interest payments and may include a fixed balloon payment. As such, the investor can seek a credit rating, which is only available for debt investments, and can create a reserve for its investment equal to a fraction of the total investment. The transaction which received an exception described in the OCC letter, which uses the conventional art, does not provide any of these criteria, and has not been reviewed by the courts. The returns are variable, and there is no fixed balloon payments. In addition, the Investor is a Minority Equity investor, and even though the OCC allows banks to invest using this method, it is still equity and still requires an Investor to create a reserve equal to up to 100% of its investment. See Office of the Comptroller of the Currency, Interpretive Letter #1139. In the conventional art, the Sponsor is the Lessee, and they are the majority partner in a partnership. As such, the Sponsor consolidates the investment of the minority investor. This means that the Sponsor must use its credit capacity, which is a quantifiable number, this decreases their available credit capacity for other uses. The teaching of this invention improves the process by providing a method for achieving the same investment while not increasing either liabilities or assets for the Sponsor/Lessee. The reduction of liabilities as compared to the conventional method directly increases credit capacity. Having additional credit capacity is a new and useful improvement (detailed further below). In addition, the increased credit capacity directly improves financial ratios for the Sponsor in a factual way.

This is not a business method for reducing or deferring taxes, but rather a method to increase the efficiency for a pre-established amount of taxes and deferral of taxes that may be available to a renewable power generation project.

### Description of Related Art

Generally, there are two primary types of investments: debt investments and equity investments. While equity investments typically have a higher rate of return than debt investments, equity investments are viewed as a higher risk, because equity capital is the first to be lost, and the rate of return is based on the economic performance of the investment. The returns on an equity investment, in renewable generation in particular, are variable and typically do not have a fixed repayment schedule. Therefore, equity investments are typically made based on the investor's ability to calculate and/or bear the risk of the investment and the variability of returns and potential losses from the investment. Because of the risks associated with equity investments, entities typically do not invest in projects in which they lack familiarity and/or the ability to adequately evaluate the risk.

Problems exist in certain complex industries where equity investments are needed but hard to obtain due to the limited ability of investors to evaluate their risks. An example of one of these complex industries is renewable energy power generation, including, but not limited to, wind power generation. In addition, wind power generation (and other power generation) is subject to variability due to the variability of wind strength that may affect the reliability of power generation, and in addition the power consumption may vary in a way that affects related power demand and related revenues.

In addition, although renewable energy generation is attractive for many reasons, qualifying as the active owner and operator may prevent some approaches for accounting for the risk of equity investment as a debt investment. For example, with respect to tax credits, United States tax code 26 U.S.C. § 45 (“Section 45”) provides that investors can receive a production tax credit (“PTC”) for electricity produced by renewable resources, including wind. However, the PTC is only available to those investors who are both the owner and the operator of the power generation facility which is typically considered an equity investment. These requirements for the production tax credit may traditionally have prevented investors from advantages of, e.g. from a regulatory and accounting standpoint, of debt investment treatment, such as the lesser risk of the investment and a fixed principle and interest payment stream, among other things. The current market standard structure, in use in the Energy Industry since the 1980's and in renewable energy since 2003, uses a structure where the equity investor is considered a Minority Equity participant. This investment, by its nature, is considered an equity investment and does not have a fixed principal and interest payment stream.

Advantages exist for equity investments in wind power generation projects to be viewed as net leases. For example, the Office of the Comptroller of the Currency considers an investment using risk shifting to be a debt like investment. However, banks may be required to limit the total dollar amount for this approach. On the other hand, if the wind power generation investment meets the criteria to be considered a net lease, banks may have no limit on making these investments. Corporate investors will often employ similar self-regulated criteria for their investments. The reason that a net lease may be used is that national banks may act as lessors and finance “net leases” for personal property. In a net lease, the bank is not directly or indirectly obligated to assume the expenses of maintaining the property. This does not prohibit the bank from arranging for an independent third party to provide servicing, repair, or maintenance of the leased property during the lease term. (page 2 of the OCC Handbook). A net lease is one that does not, directly or indirectly, obligate the bank to provide maintenance, insurance, parts, or accessories for the asset. National banks are not prohibited from arranging for an independent third-party provider to perform these services at the expense of the lessee. The current invention allows the investor to meet all of the criteria listed above for a net lease.

Certain types of debt investments may also be difficult to successfully implement in a wind power generation project, such as a net lease, or other similar debt investment. In particular, requirements for financial accounting for leasing may change over time. These changes, and a primary benefit of the invention, are not related to the tax treatment of the transaction, but only the financial accounting and regulatory requirements. For example, such changes may require Lessors (aka the Investors) to show operating losses on their income statement for the depreciation of the equipment and potential interest expenses for associated debt instead of showing the net after-tax economic benefit as a net positive as the industry had done before. Accordingly, there is a need for a method of transforming equity investments in renewable energy power generation, such as wind power generation, into a financial arrangement that shifts the risk in the investment in a manner that allows the investor to qualify for criteria that will allow for the financial accounting for the investment as an investment in a series of Equity Linked Notes where the notes that have a fixed and determinable payment stream including final settlement that may qualify for Interest Method accounting while maintaining the investor as the owner and operator of the investment. This approach is beneficial whether or not there is a tax credit or a tax depreciation benefit as it solves a problem that exists with or without the tax credits or beneficial tax depreciation. Particularly, there is a need for a method where the investment is considered a net lease for OCC regulatory purposes and for financial accounting for the Lessor, such that the equity investment in a wind power generation project can be converted into an investment in a series of Equity Linked Notes where the notes that have a fixed and determinable payment stream including final settlement and may thus qualify for interest method accounting. The interest method received approval from the Accounting Principles Board in 1967, As stated in APB Opinion No. 12, “Questions have been raised as to the appropriateness of the “interest” method of periodic amortization of discount and expense or premium on debt (i.e., the difference between the net proceeds, after expense, received upon issuance of debt and the amount repayable at its maturity) over its term. The objective of the interest method is to arrive at a periodic interest cost (including amortization) which will represent a level effective rate on the sum of the face amount of the debt and (plus or minus) the unamortized premium or discount and expense at the beginning of each period. The difference between the periodic interest cost so calculated and the nominal interest on the outstanding amount of the debt is the amount of periodic amortization . . . . In the Board's opinion, the interest method of amortization is theoretically sound and an acceptable method.” APB Opinion No. 12 Omnibus Opinion—1967 and reaffirmed APB Opinion No. 21 Interest on Receivables and Payables.

In addition, other accounting treatments available to other sectors such as affordable housing may not be available for use with renewable energy projects.

The current disclosure discussed herein also meets earlier, and still valid, criteria for utilization of the interest method. This criteria is included in the Exposure Draft (Revised) Accounting for the Sale or Purchase of Tax Benefits through Tax Leases, 1982. To restate, the current disclosure herein is beneficial in its conversion of an equity investment into a debt instrument and does not require tax benefit or beneficial depreciation. Prior to a change of law, the purchase and sale of tax benefits was allowed. FASB proposed, through an Exposure Draft in 1982, that investors could use a version of the interest method for accounting for the purchase and sale of tax benefits that met certain criteria:
1. Limiting the partner's return on its investment by having excess cash flows distributed to the general partner,
2. Limiting the profit on subsequent sale of the project, and
3. Guarantees by the general partner providing a “targeted” rate of return on the project. PWC Guide to Financing Transactions with Debt and Equity Instruments, 2014.

The disclosure herein satisfies the criteria of the Accounting Standards Codifications for Equity Linked Notes as the combination of the wind insurance, equipment insurance, and residual value insurance or put option allows the investor to meet all of the criteria listed below.
815-15-25-10 which provides criteria to determine if two securities should be joined:
   1. Economic characteristics and risks of the embedded derivative are clearly and closely related to the economic characteristics and risks of the host contract.
   2. The Put is not re-measured at Fair Value
   3. The Put is settled on a Gross basis and not on a net basis. Id.
ASC 480 states that a mandatorily redeemable financial instrument is a liability. As per the PWC Guide, “a written put option is classified as a liability under ASC 480 because it obligates the reporting entity to deliver cash to repurchase shares.” Exposure Draft (Revised) Accounting for the Sale or Purchase of Tax Benefits through Tax Leases.
1982 ASC 480-10-20: “unconditional obligation requiring the issuer to redeem the instrument by transferring its assets at a specified or determinable date (or dates) or upon an event that is certain to occur.
ASC 480-10-25-4 A mandatorily redeemable financial instrument classified as a liability if the redemption only required to occur on the liquidation or termination of the reporting entity.

### SUMMARY

In one aspect, the invention features a method for constructing a financial structure in a wind power generation project investment by shifting at least a portion of the risk of the wind power generation project investment from an investor to a guarantor(s) in a manner that allows the investor to meet the criteria for Equity Linked Notes. The method may include the investor paying a premium amount for a wind power generation project based on Tier I energy rates, Tier II energy rates, operating expenses of the wind power generation project, and the tax benefits associated purchasing the wind power generation project, obtaining a guaranteed total return floor amount for the wind power generation project, wherein the guaranteed total return floor amount is based on stress tests on the wind power generation project, wherein the stress tests include determining the efficacy of wind insurance, equipment insurance, and residual value insurance, obtaining an amount of a fixed payment associated with the wind power generation project and an amount of a variable payment associated with the wind power generation project, wherein the fixed payment is Tier I power sales energy revenue less scheduled operating expenses of the wind power generation project, and wherein the variable payment is Tier II power sales energy revenue, obtaining a wind insurance policy, an equipment insurance policy, and residual value insurance or put option backed by acceptable collateral, obtaining at least one service provider for the wind power generation project, and obtaining an asset manager for the wind power generation project in a manner that preserves the investors position as the owner/operator.

Accordingly, the entity operating the wind power generation project may be able to guarantee substantially no operating risk in the fixed payment through the insurance and put option, while providing for the fixed and variable payments over time to be provided to the investor. This permits the investor to treat the investment in the entity operating the wind power generation project as an Equity Linked Note.

By mitigating risks for the investment and accounting for potential risks particular to energy production and consumption, this structure permits an investor to convert the equity investment into a set of fixed payments (and a variable payment) that may be evaluated by the investor using an interest method of financial accounting for the fixed payment note by comparing the payments with the initial premium/investment amount made by the investor. By structuring the fixed payments to account for Tier I energy power sales (in combination with applicable insurance and put options) This allows the investor to have high confidence (95-99%) that the payments will be made as a fixed and scheduled stream of income. Because of this treatment and the reduced (or eliminated) liability, the investor may invest in a similar size project with a lower effective credit usage, which may permit additional projects to be funded by the investor. E.g., treatment of the investment via the interest method may also permit the investment to be evaluated at a present value using a lower discount rate due to the shifting of significant risk, thereby enabling reduced impact on capital investment by the investor. For example, the current market standard business method requires the investor to reserve, using the concept of prudential capital management, for its entire investment because it is a Minority Equity investment. Using the disclosed approach, the investor would, while using the concept of prudential capital management, reserve for only a fraction of its investment in the Equity Linked Notes.

Implementations may include one or more of the following to take advantage of the interest method accounting and lower prudential reserves. The fixed payment may permit the investor to leverage the fixed payment, and thereby invest in additional projects relative to what may be available with an equity-based approach. The method may include entering into operating debt or securitizations of future cash flows based on the fixed payment. The method may include entering into a securitization of future equity capital contributions from the investor based on agreed rate per unit of Tier I production. The financial structure used by an investor may be a service contract, a net lease, or an inverted lease or a purchase and sale agreement with a Management Agreement. The financial structure may simultaneously be a service contract and a net lease and an Equity Linked Note or any combination thereof.

The investor may receive (i.e., use the investment to purchase) a Note Receivable or a series of Note Receivables from the Seller or from a Trust established for the sole purpose of issuing the Note or Notes and the Trust holding all of the investment security. The Trust itself may be considered a structured Guarantor as it may be supported by the equipment insurance, the wind insurance, the future investor capital contribution, if any, the Tier I energy revenue, and the residual value guaranty or Put option. The Trust may receive additional support in the form of a guarantee of the Trust's performance. This may be a financial guaranty or reinsurance. The primary Note will be based on a fixed payment schedule as insured by the wind insurance and equipment insurance. The fixed payment schedule may also fix the amount of the tax benefits or their pre-tax cash equivalents. The Final Settlement on the Note will be paid from the proceeds of the Put option which are backed by acceptable collateral. The financial structure allows for the creation of additional Notes with a fixed payment schedule backed by the uninsured cash flow and tax benefits from the investment. The Final Settlement for these Notes will be paid using a portion of the Put option proceeds which are backed by acceptable collateral. Lastly, there will be at least one Note with variable returns that are paid out of the residual cash flow. The Note Holders will share in the voting rights on a pro rata basis or on any other basis that is acceptable to all parties.

In general, in another aspect, the invention features a method for creating a net lease in a renewable power generation project investment by shifting at least a portion of the risk of the renewable power generation project investment from an investor to a guarantor(s). The method includes purchasing a renewable power generation project for a pre-determined premium amount, wherein the pre-determined premium amount is based on Tier I energy rates, Tier II energy rates, operating expenses of the wind power generation project, and leasing the renewable power generation project to the guarantor(s), wherein leasing the wind power generation project includes receiving a fixed rent amount based on Tier I power sales energy revenue that is in-substance fixed because of the equipment insurance and wind insurance, receiving a variable rent Tier II power sales energy revenue, and receiving residual value insurance, obtaining at least one service provider for the wind power generation project, and the ability to obtain an unrelated party to the investor or the developer an asset manager for the wind power generation project in a manner that preserves the investors position as the owner/operator of the wind power generation project. The particular contract with the asset manager may be negotiated between the parties and is not essential to the disclosed approach, while allowing the unrelated party to be responsible for operating decisions. The Investors investing in the Net Lease would then purchase a Note Receivable or a series of Note Receivables from the Seller or from a Trust established for the sole purpose of issuing the Note or Notes and holding all of the investment security as described above.

These steps may be performed by an project sponsor in conjunction with an investor to establish and operate the renewable power generation project. In particular, a seller may sell the project to the investor and enter a management agreement (directly or with a trustee/special purpose entity) for operation of the project.

Implementations of the method may include each investor purchasing a joint undivided interest in the investment subject to a joint operating agreement between the co-owners. The invention provides investors with the ability to create undivided interests where each investor is a co-owner. This is possible because each investor, using the invention, is able to delegate the authority to make decisions for the renewable power generation facility to an unrelated party. The mode of investment is described above.

The Sponsor benefits from the Equity Linked Note structure as it does not have to capitalize a right of use asset or a lease liability on its balance sheet as it otherwise would have to do based on the Accounting Standards Codification 842 for leases implemented on Jan. 1, 2019 and retraoactively effective for all leases. The reason for this is that the Tier I payments do not have a minimum purchase guaranty from the Sponsor, but rather rely on the equipment insurance and weather variability insurance to create in-substance fixed payments.

These approaches may be implemented in various types of investments, including wind power generation, solar energy, bio-mass, bio-fuels, geothermal, wave power, hydro power, or battery storage combined with any of the above using the Equity Linked Note structure described herein. The structure will combine equipment insurance with resource insurance (e.g. wind insurance or irradiation insurance for solar) and the Put option backed by adequate collateral or a Residual Value Guaranty.

### BRIEF DESCRIPTION OF THE DRAWINGS

These and other features will be more clearly understood from the following detailed description taken in conjunction with the accompanying drawings and claims, wherein like reference numerals represent like parts.

FIG. 1 shows a flow chart of a risk shifting method, according to an exemplary embodiment.

FIG. 2 shows a flow chart of a method of transforming an equity investor in a wind power generation project into an investor in a series of Equity Linked Notes using the risk shifting method of FIG. 1.

FIG. 3 shows a power sales agreement, according to an exemplary embodiment of the net lease where the Tier I energy and associated revenue and tax benefits are covered by at least one risk mitigant.

FIG. 4 illustrates a diagram of the method of FIG. 1 viewed as a power sales and service contract, according to an exemplary embodiment;

FIG. 5 illustrates a diagram of the method of FIG. 2 viewed as a net lease agreement, according to an exemplary embodiment.

FIG. 6 illustrates a diagram of the method of FIG. 2 with the Trustee acting as de facto guarantor(s).

FIG. 7 illustrates a diagram of the method of FIG. 6 where each investor owns an undivided interest in the Trust or Special Purpose Entity.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The disclosed systems and methods provide structures for renewable energy power generation investors to shift their risk in renewable energy power generation projects to a guarantor(s), while maintaining the role of owner and operator of the renewable energy power generation project, such that the investors may qualify for interest method accounting and the Sponsors may qualify as a Lessee without creating either a Right of Use Asset or a Lease Liability providing the Sponsor with a clear benefit over the current art that would require them to add assets and liabilities to their balance sheet. Interest method accounting allows investors to book the positive economic results of their investment on an after-tax basis as opposed to booking net operating losses as they would otherwise have to with the new accounting standards for leases.

It should be noted that embodiments of the present disclosure are applicable to any form of renewable energy investment. Additionally, the renewable energy power generation investments may be any power generation projects produced by renewable resources, including, but not limited to wind.

Embodiments of the present disclosure incorporate the risk shifting systems and methods disclosed in U.S. Pat. No. 7,853,461 (“the '461 patent”) and U.S. patent application Ser. No. 14/871,314 (“the '314 application”), the contents of each of which are incorporated herein by reference in their entirety. The '461 patent teaches how to more efficiently manage the risk of a renewable power generation project and create benefits from this reduction of risk irrespective of any tax considerations.

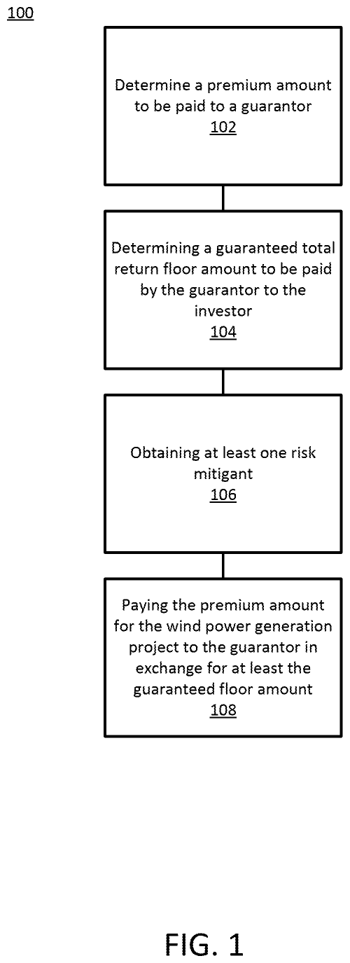

For example, the flow chart of FIG. 1 shows a method 100 for shifting at least a portion of the risk associated with a wind power generation project investment from an investor to a guarantor(s). The method 100 may include determining a premium amount to be paid to a guarantor(s) 102. The guarantor(s) may be any individual and/or entity or structured entity who possesses the ability and/or knowledge to assess risks associated with investments in wind power generation projects. The guarantor provides a mitigant for a type of risk for the wind power generation project, such as operating condition risk (e.g., wind strength), equipment risk (e.g., equipment replacement or malfunction), or residual value risk (e.g., that the residual assets are worth more or less than expected at the end of a particular time period). The risk mitigant is typically an insurance for each type of risk, such that if the risk occurs and the wind power project under performs or has an unexpected cost, the guarantor will compensate for the difference. For example, an operating condition risk accounted for by wind insurance may account for revenues or wind below a threshold for a given time period. For residual value, the guarantor may provide a residual value insurance or may offer a put option related to collateral of the wind power generation project.

The risk shifting method 100 may further include determining a guaranteed total return floor amount expected for the project. This floor may be on a pre-tax basis or a post-tax basis, but does not purport to create or convey any tax benefit from tax credits or tax depreciation. Though the revenue is expected for the project, the total return floor amount may be “guaranteed” from the perspective of return to be provided to the investor, due to the risk mitigant offered by the guarantor, such that the combination of actual net revenue along with the proceeds from any risk mitigation (e.g., if an adverse event occurs impacting the related type of risk) are at least the total return floor amount or the amount of a fixed note payment. In some embodiments the guarantor is responsible for providing revenues related to the project and providing the guaranteed total return floor amount or fixed note payment to be paid to the investor 104. In some embodiments, the guaranteed total return floor may first be calculated based on anticipated assets of the renewable power generation project, including but not limited to tax credits, pre-tax cash flow, post-tax cash flow, dividends, or combinations thereof. After calculating the guaranteed total return floor amount, the amount may be quantitatively and/or statistically determined based on stress tests on the renewable power generation project in order to ascertain that the floor amount provides the investor with an acceptable return for its investment based on the risks and rewards of the investment. For example, in some embodiments, the stress tests may be based on renewable power generation project assumptions and/or factors such as plant availability based on forecasts for wind speed at the plant site. In some embodiments, the guaranteed total return floor amount may be configured to be paid by the guarantor(s) to the investor in the form of a single payment at an agreed upon time. Alternatively, in some embodiments, the guaranteed total return floor amount may be configured to be paid by the guarantor(s) to the investor periodically for an agreed upon term.

FIG. 1 shows that the risk shifting method 100 may further include obtaining at least one risk mitigant 106. The at least one risk mitigant may be obtained by the investor and/or the guarantor(s) and may include any financial and/or structural support that may be configured to mitigate the guarantor(s)'s risk in the wind power generation project. The mitigants may be obtained to ensure that the expected total return floor amount or fixed note payment is paid as a combination of the actual net revenues of the power generation project in combination with proceeds of the risk mitigants. The risk mitigants may include mitigation of operating condition risk, equipment risk, and residual value risk. Operating condition risk refers to risks related to operation of the power generation project, and may be affected by environmental operating conditions of the power generation project that affect power generation and capacity of the project to meet energy demands (and thereby generate revenue). The equipment risk relates to risks that equipment for the project is inoperable or does not meet expected service quality, for example if a component breaks or is out of service, thereby causing the power generation project to be at least partially unable to convert operating conditions to power generation. Residual value risk refers to the risk that the residual value of the assets of the project fall below initially projected value of assets at the end of a time period, such as an expected project end or a final payment of the fixed or variable note.

In some embodiments, for example in a wind power generation project, the at least one risk mitigant may include, but is not limited to, wind insurance, wind power generation equipment insurance, residual value insurance, a put option with appropriate collateral, and/or combinations thereof. The risk shifting method 100 may be configured such that the investor may pay the guarantor(s) the pre-determined premium amount for the wind power generation project in exchange for at least the guaranteed total return floor amount 108. In some embodiments, payment of the pre-determined premium amount to the guarantor(s) may be conditioned upon the guarantor(s) obtaining the at least one risk mitigant.

The risk shifting method 100 may be structured such that the investor in the wind power generation project may receive PTC's under the United States tax code. Particularly, 26 U.S.C. § 45 sets forth that PTC may be received for electricity produced by renewable resources, including wind, and sold to an unrelated person. Section 45 further sets forth that in order for a taxpayer to receive the PTC, the taxpayer must be both the owner and the operator of the wind power generation project. Accordingly, in some embodiments, the steps associated with the risk shifting method 100 may be structured within a method such that the investor in the wind power generation project may be viewed as both the owner and the operator of the wind power generation project. They are the owner because they are exposed to the risks and rewards of the wind power generation project. They are using the risk shifting mechanism and the current invention to shift the operating risk to counterparties standing behind the risk shifting contracts. They are the signatories to the insurance contracts that mitigate their risk. They are the signatory for the unrelated asset manager who will operate the asset on their behalf in accordance with the requirements of the M&M court case. They have to approve the operational plans of the asset manager and have the right to hire or fire the asset manager. The form of contract for the manager is not relevant to the invention. The invention makes it possible for an investor to own the project and hire an unrelated manager in a way that meets the criteria of debt outlined in the M&M case.

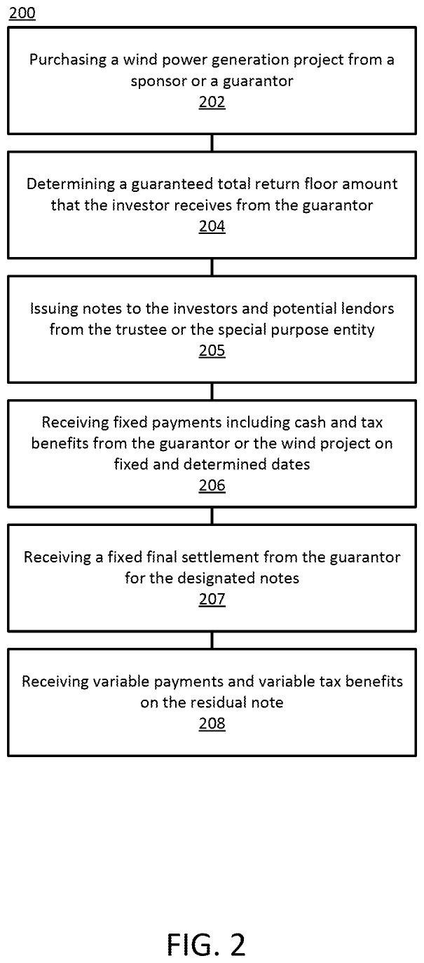

FIG. 2 shows a flow chart of a method 200 that allows an equity investor in a wind power generation project to qualify for the PTC, using the risk shifting method of FIG. 1 in a manner that allows the investor to create a note receivable based on “contractual rights to receive money or contractual obligations to pay money on fixed or determinable date”.

The method 200 may first include the purchase of a wind power generation project from a sponsor, a sponsor who is also a guarantor, or a guarantor(s) 202 and after establishing the guaranteed total return floor establishing a Trustee or other Special Purpose entity to hold the collateral for the wind project 205. A sponsor may be an entity that prepares power generation projects and coordinates establishment of the related contracts and financial structures, and may guarantee the project itself or through an affiliate, or may work with an unrelated company as the guarantor. The collateral includes the proceeds from the equipment insurance, the proceeds from the weather variability insurance, the collateral for the Put, the energy revenue, and the payments for any purchase of the Investors interests. The Investor may place all of its ownership interests in the renewable power generation asset in the Trustee. The Trustee or the Special Purpose Entity would then issue a series of notes which the investor would purchase 205. For example, in some embodiments, the sponsor or the guarantor(s) may construct the wind power generation project and sell it to the Trustee, on behalf of the Invetors, in exchange for the proceeds from the series of Notes. In this scenario, the Trustee holds all of the ownership interests in the renewable power generation project. This amount may or may not include a fee for the Sponsor or the Guarantor(s) who may guaranty the Trust. This fee may be paid directly by the Investor or by the Trust on their behalf.

The premium amount may be a pre-determined monetary value that the investor and/or guarantor(s) calculates the wind power generation investment to be worth. The premium amount may be determined based any desired factors that may be associated with the wind power generation project, including, but not limited to, the energy rate for the amount of production covered by the risk shifting, and the energy rate for the excess production, operating expenses of the wind power generation project, and tax benefits that may be associated with investments in the wind power generation project. In some embodiments, the premium amount may be calculated and/or defined as the investment is worth by evaluating the project when using the risk shifting method 100 of FIG. 1 and the method 200 disclosed herein that converts the investment into a series of Notes less the amount the investment would be worth without these techniques. Alternatively, or in addition, in some embodiments, the premium amount may be determined based on the weighted average cost of capital (“WACC”) for the wind power generation investment. For example, the WACC for a wind power generation investment using the risk shifting method 100 of FIG. 1 and the method 200 of converting the investment into series of Notes of FIG. 2 will be materially lower than the WACC for a wind power generation investment that does not use the methods 100, 200 of FIGS. 1 and 2 due to the lowering of risk and the increasing liquidity of the investment that can now be sold as an Equity Linked Note. More particularly, in some embodiments, the WACC for a wind power generation investment without the methods of FIGS. 1 and 2 may be in the 8.5% to 10.5% range, whereas the WACC may be lowered to a 5% Guaranteed Floor range with an expectation of a 6.5%. return using the methods 100, 200 of FIGS. 1 and 2, which may be more marketable to investors.

The investor, which may be an individual, investment partnership or joint operating company, will control all of the voting interests in the Wind Power Generation project company and may have the authority to hire and/or fire each of the service providers to ensure the investor maintains control over the project and (when applicable) qualify for investment credits. Additionally, the investor may be authorized to take reasonable and appropriate action to protect the value of the wind power generation project or its interests under the financial structure if there is a change in condition, such as a change that may threaten the investor's financial position by increasing its exposure to loss. The investor may also have the authority to hire and/or fire one or more asset managers who manage the project. The investor and the guarantor(s) may delegate decision-making authority to the one or more asset managers with the exception of decisions deemed to be necessary due to a change in condition. The delegation of decision-making authority to the one or more unrelated asset managers may be possible, in a manner that allows the Sponsor to not recognize a Right of Use Asset or a Lease liability, and, or allow the Investor to delegate day to day decision making because risk shifting may be configured to reinforce stability of the wind power generation project.

In some embodiments, the method 200 may also include the investor obtaining additional funding or loans based on the cash flow of the investment. Such additional funding or capital has a lower cost as it is debt capital. The additional funding replaces the investors Equity investment allowing them to allocate funds to finance additional projects. For example, if an Investor has $100 to invest, but is only required to invest $50 because of the additional funding, the Investor will be able to invest in an additional project(s) with their remaining $50. Additional funding in 205 may include operating debt based on the fixed payment (commonly referred to as Project Finance Debt). In some embodiments, the operating debt or a pre-payment from the power purchaser may be secured using the investors operating cash flows under Tier I and the equipment insurance and weather variability insurance. For example, the principal and interest payments of the fixed payment for Project Finance Debt may be calculated using industry standard conventions. However, the debt service coverage ratio may be set at a lower level than standard to reflect the lower level of risk. Alternatively, or in addition, entering into Project Finance Debt 205 may include a securitization of any future investor capital contributions based on a pre-agreed amount per unit of energy production. This pre-agreed amount will be insured by the equipment insurance and the weather variability insurance. For example, in some embodiments, the investors may agree to contribute up to $2.5 for every megawatt hour of energy that the renewable power generation project generates. This capital contribution may then be used as the cash flow available for debt service. This funding may be considered a Project Financing or a Securitization of Future Equity Capital Contributions. Because of the presence of insurance, the debt service coverage ratio may be set at a lower level than standard to reflect a lower level of risk in the wind power generation investment.

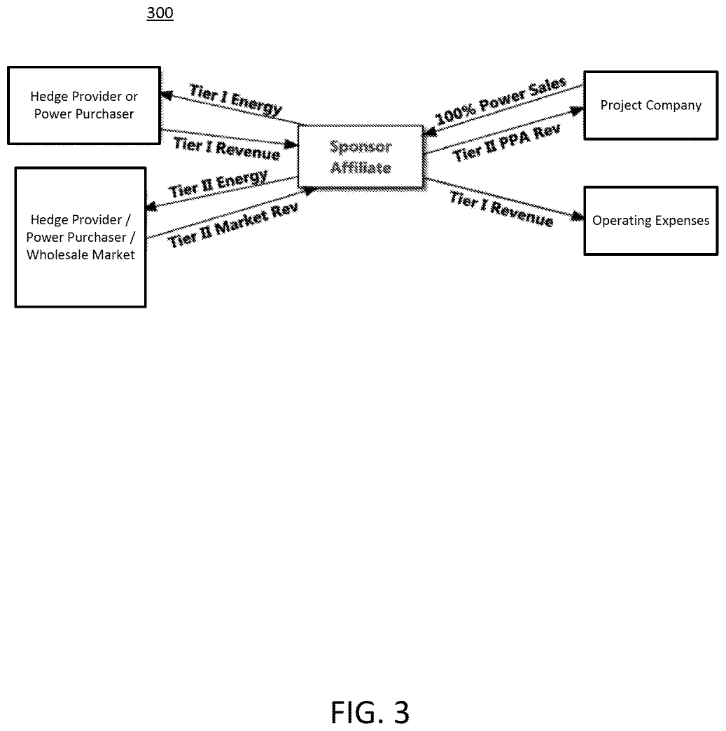

FIGS. 3-6 illustrate various diagrams showing how the method 200 of FIG. 2 may be viewed and/or documented for tax, regulatory, and/or accounting purposes. For example, as previously discussed, the method 200 may include constructing a financial structure such that the investor receives a fixed note(s) and a variable note from the Trustee or Special Purpose Entity 205 and further that the fixed note(s) and variable note may be based on Tier I and Tier II energy revenues. In some embodiments, and as illustrated in FIG. 3, the financial structure include a power sales agreement between a project company operated by the investor and secured collection account, which may take the form of a Trust, operating as the guarantor(s). The sponsor affiliate may be an entity operated or affiliated with the sponsor that operates to purchase power from the project company and contract with purchasers of such power.

In the embodiment FIG. 3, the lessee may be the guarantor(s), and the project company may be the owner/investor of the wind power generation project. The power sales agreement of FIG. 3 may be structured to be responsible for 100% of energy sales to external parties from the wind power generation project. Alternatively, in other embodiments, the power sales agreement may be structured to cover any percentage of energy sales as desired by the investor and/or the guarantor(s). As illustrated in FIG. 3, the Tier I power sales may be set at an energy rate to cover the operating expenses of the wind power generation project net of insurance proceeds and the actual or hypothetical principal and interest payments. The rate cannot be set at a level that is lower since the project must pay its operating expenses. The cash flow available for debt service may be established using an amount of Tier I energy sales revenue that is less than or equal to the insured level of Tier I energy sales revenue less the maximum operating expenses for the wind power generation project, assuming the insurance. This resulting amount may be used to amortize the debt by creating a principal and interest schedule. In some embodiments, such as the embodiment of FIG. 3, the Tier I power sales may be backed by adequate credit support from the guarantor(s) and/or guarantor(s)'s affiliate and/or may be backed by an acceptable energy hedge or power purchase agreement (“PPA”).

FIG. 3 illustrates that the power sales agreement may be structured such that the project company/investor may receive at least a portion of the Tier II power energy sales revenues. Additionally, FIG. 3 illustrates that in some embodiments, the Tier II power energy sales revenue may not be backed by credit support; however, the Tier II revenue must be at a level that may be low enough for the investor to perceive that he/she is not taking an unacceptably high commodity risk. For example, in some embodiments, the level of Tier II revenue may be low enough for the investor, who does not have the security of the insurance and/or other credit support other than the obligation of the Sponsor to purchase the Tier II energy, to have an acceptable level of commodity price risk.

In lieu of a Tier II energy rate, the power sales agreement may be structured with only one tier and may be with a party other than the Sponsor Affiliate. This embodiment may be combined with a Management Agreement with the Sponsor where the Sponsor receives management fees for management of the project. These fees may take the form of a fixed amount or set based on a percentage of a parameter such as a percentage of net income or a percentage of revenue or other parameter. The management contract terms will not interfere with the investors' ownership claims on the wind power generation facility.

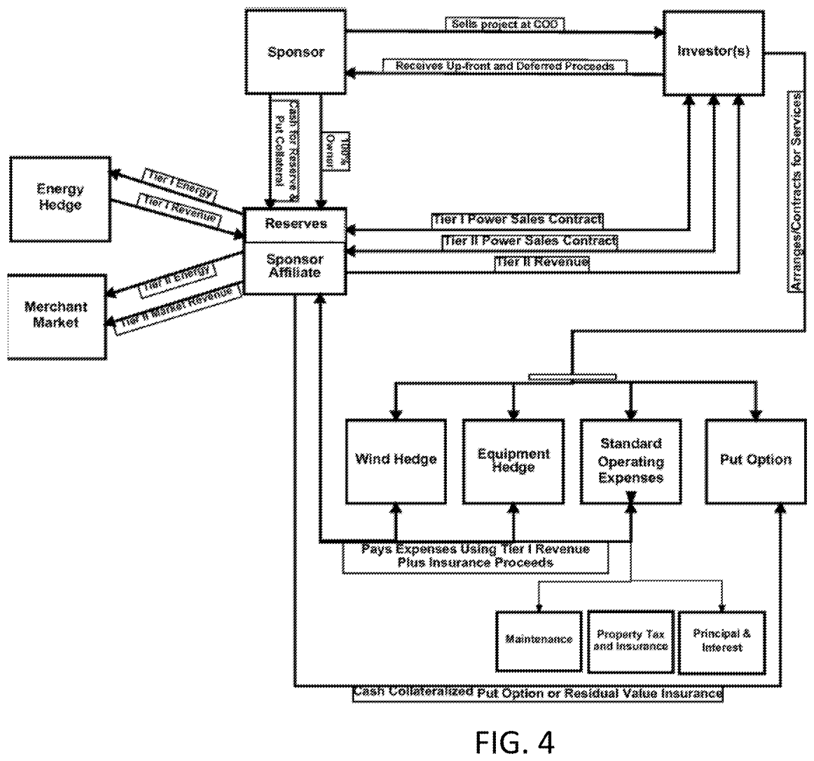

FIG. 4 illustrates a diagram showing the method 100 of FIG. 1 being viewed as a power sales and service contract, according to an exemplary embodiment. In the embodiment of FIG. 4, the sponsor affiliate may be the guarantor(s), and the credit behind the guarantee may be based on the strength of the guarantee package that risk shifting may provide. For example, in some embodiments, the guarantee may be based on contractual risk mitigation that includes wind insurance, equipment insurance, residual value insurance, and/or a put option that may be backed by acceptable collateral. These may provide guarantees against operating condition risk, equipment risk, and residual value risk of the project. Additionally, in the embodiment of FIG. 4, the sponsor affiliate (i.e., the guarantor(s)) may choose to provide the investor with an explicit guaranteed of a guaranteed total return floor amount. Alternatively, the sponsor affiliate may choose to package different element of risk mitigation to provide an implicit synthetic floor. Though the hedges are shown in FIG. 4 as between the investor and sponsor affiliate, these may be arranged by the sponsor affiliate for the benefit of the investor and to provide revenue to ensure payment of the fixed note.

As previously discussed, in some embodiments, the investor may construct a financial structure that may be viewed as a service contract for tax purposes. Particularly, the service contract may be advantageous because it is a financial structure that allows the investor to qualify for the PTC under the United States tax code. FIG. 4 illustrates that when the method 100 is viewed as a service contract, the investor may be the owner and operator of the wind power generation project based on the investor's role with respect to the Tier I and Tier II power energy sales contract with the sponsor affiliate operating as guarantor(s) and based on the investors role in arranging contracts for services for the wind power generation project.

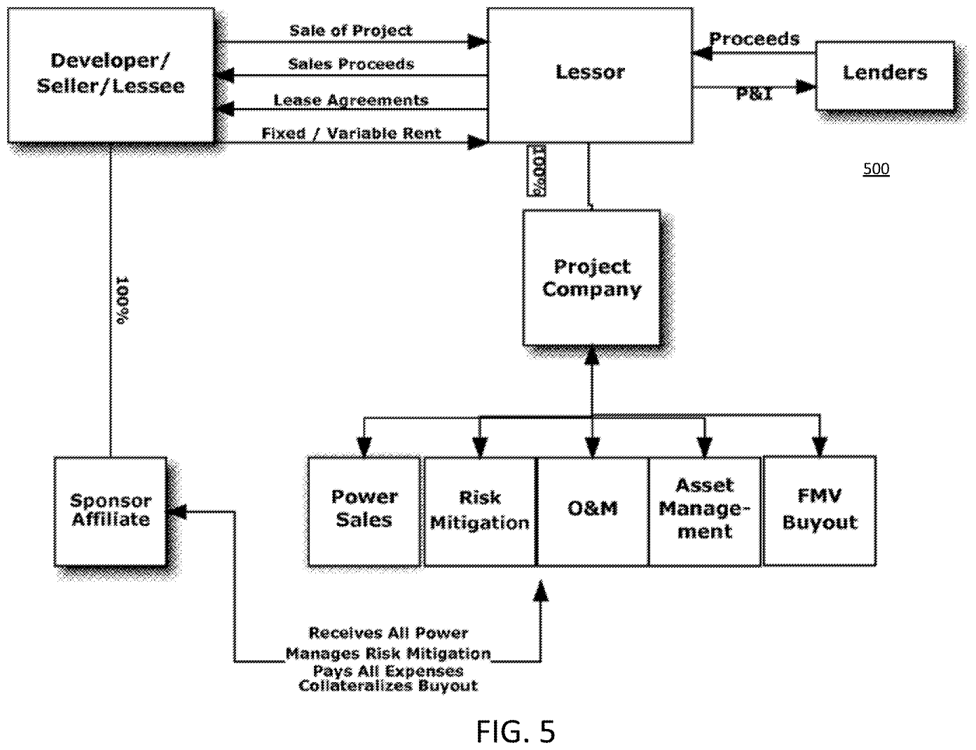

FIG. 5 shows a diagram of how the method of FIG. 1 may also be viewed as a net lease for regulatory and/or accounting purposes. In the embodiment of FIG. 5, investor may operate as the lessor and the developer/seller/lessee may be the guarantor(s). In this example, a project developer may initiate and prepare the project and subsequently sell the project to the investor, which subsequently leases the project to the developer operating as a lessee on the project. Thus, as illustrated in FIG. 5, the financial structure disclosed in the method 100 of FIG. 1 may be structured such that after the investor purchases the wind power generation project, the investor may lease the wind power generation project to the guarantor(s) in exchange for the fixed and variable payments, i.e., rent, and in exchange for obtaining at least one risk mitigating feature, including, but not limited to insurance. In some embodiments, the investor may lease the wind power generation project in a manner that ensures that the investor may earn satisfactory pre-tax yields, i.e. to satisfy the economic substance requirement and after-tax yields, i.e., to provide the investor an adequate return on its funding cost based on the risk of the investment.

Additionally, similar to the embodiment of FIG. 4, the investor may be provided with a guaranteed total return floor amount explicitly from the guarantor(s), or alternatively may be provided with an implicit guarantee from the guarantor(s) to produce a guaranteed total return floor amount. As previously discussed, the sufficiency of the guaranteed total return floor amount may be quantitatively and statistically determined based on stress tests on the wind power generation project. FIG. 5 further illustrates that the method of FIG. 5 may be viewed as a net lease, because the structure of the method 100 satisfies the criteria for classification as a net lease identified by the Office of the Comptroller of the Currency (“OCC”). The OCC definition sets forth that under a net lease, the lessor will not provide or be obligated to provide servicing, repair, or maintenance during the lease term, parts or accessories for the leased property, loan replacement or substitute property while the leased property is being service, payment of insurance for the lease, and renewal of any license or registration for the property unless renewal by the lessor is necessary to protect the interest as the owner or financier of the property.

The structure of the method 100 may also satisfy the criteria for classification as a net lease according to generally accepted accounting principles, which may treat the method 200 of FIG. 2 as a lease financing. According to the Financial Accounting Standards Board's Accounting Standards Codification 840 (“ASC 840”), a reporting entity assesses whether an arrangement contains a lease based on its substance, which depends on an identified power plant and conveys to the purchaser, i.e., the lessee/guarantor(s), the right to control the use of the power plant. More particularly, according to ASC 840, if any of a number of specified conditions are met and there is specific property, plant, and equipment, then the arrangement is a lease. The specified conditions include: (1) the purchaser has the ability or right to operate the property, plant, or equipment or direct others to operate the property, plant, or equipment in a manner it determines while obtaining or controlling more than a minor amount of the output or other utility of the property, plant, or equipment. The purchaser's ability to operate the property, plant, or equipment may be evidenced by (but is not limited to) the purchaser's ability to hire, fire, or replace the property's operator or the purchaser's ability to specify significant operating policies and procedures in the arrangement with the owner-seller having no ability to change such policies and procedures; (2) the purchaser has the ability or right to control physical access to the underlying property, plant, or equipment while obtaining or controlling more than a minor amount of the output or other utility of the property, plant, or equipment; and (3) facts and circumstances indicate that it is remote that one or more parties other than the purchaser will take more than a minor amount of the output or other utility that will be produced or generated by the property, plant, or equipment during the term of the arrangement, and the price that the purchaser (lessee) will pay for the output is neither contractually fixed per unit of output nor equal to the current market price per unit of output as of the time of delivery of the output.

FIG. 5 and the method of FIG. 1 illustrate that the above regulatory and accounting definitions may be satisfied as a result of risk shifting from the investor to the guarantor(s). For example, in the embodiment of FIG. 5, and as previously discussed with respect to the method 100 of FIG. 2, the guarantor(s), rather than the investor may be responsible for setting criteria that cannot be changed for and paying for wind insurance, wind power generation project equipment insurance, and residual value insurance. Additionally, the guarantor(s), rather than the investor, may be responsible for payment of the wind power generation project's operating expenses.

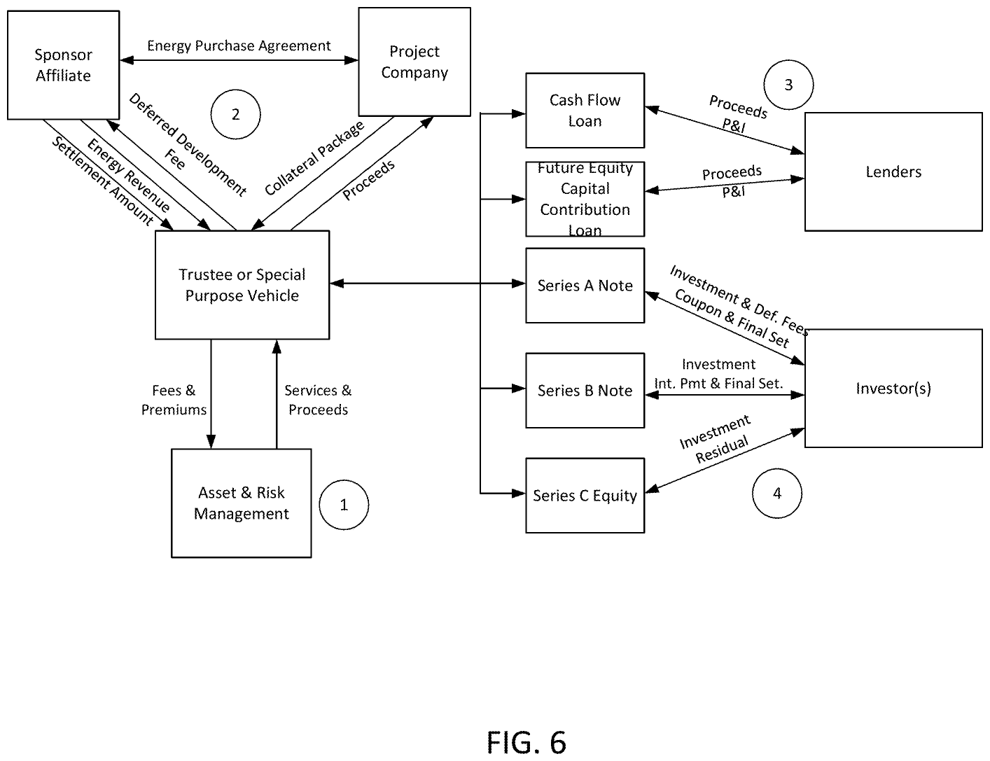

FIG. 6 illustrates an embodiment for implementing a net lease to create Equity Linked Notes. As illustrated in FIG. 6, the Trustee or Special Purpose Vehicle is now placed between the Sponsor and the Project company, and the Investors. The Trustee or Special Purpose Vehicle is an entity that serves as a collection account to securely receive all energy revenue from the Sponsor, all insurance proceeds, whether paid by the Sponsor or the Investor, any Future Investor Capital Contributions, any collateral provided under the Put or residual value guaranty, and any payments for a purchase of the Investor's interests by the Sponsor. The Trustee or Special Purpose Vehicle now holds the collateral package and all revenues, fees, and proceeds are controlled by this new entity which is now guarantor based on its holding all of the above collateral. The Trustee or Special Purpose Entity now issues a series of Notes and acts as guarantor(s) as the revenues, expenses, and proceeds from the equipment insurance, the wind insurance, and the Put or Residual Value Guaranty flow through it. The Trustee or SPE will make payments to the extent that there is cash available in the Trust or SPE from the above sources i) Operating Cash Flow loan Note, ii) Securitization of Future Investor Capital Contributions, iii) Series A Note with a fixed and determined payment of principal and interest which is backed by cash flow and tax benefits that are supported by the wind insurance and/or the equipment insurance with a Final Settlement that is supported by a portion of the Put or Residual Value Guaranty, iv) Series B Note with a fixed and determined payment of principal and interest with adequate debt service coverage based on the variable cash flow from the win power generation with the Final Settlement supported by a portion of the Put or Residual Value Guaranty, and v) Series C Note which is supported by the residual cash flow and residual tax benefits. In other embodiments, there may be fewer or more series of notes. Only the notes with fixed and determined principal and interest with Final Settlement supported by the Put or the Residual Value Guaranty may receive interest method accounting as an Equity Linked Note.

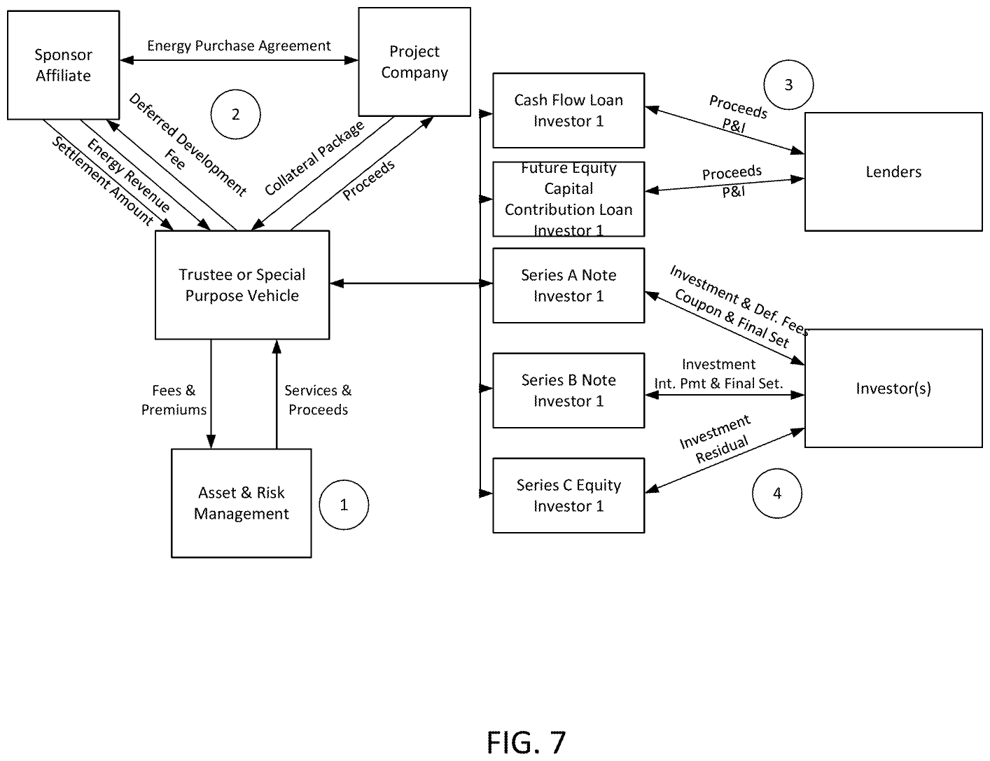

FIG. 7 illustrates a diagram of the method of FIG. 6 where each investor owns an undivided interest in the Trust or Special Purpose Entity. In this example, the undivided interests can be accounted for as an interest by the Investor in 100% of the investment vehicle which allows for an investor to consolidate its investment in a 100% controlled vehicle. The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

It is not commercially viable to implement the invention without the steps described in [0058] to [0061] as the number of computations required cannot be undertaken by pen and paper within a commercially viable timeframe. Thus, the machine implementation is essential to the usefulness of the invention.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for investment in a power generation project that shifts at least a portion of a risk related to the power generation project while permitting an investor to account for the investment as equity linked notes, comprising:
determining a premium amount for a power generation project based on energy rates, operating expenses of the power generation project, and tax benefits associated with the power generation benefit;
determining a guaranteed total return floor amount for the power generation project, the guaranteed total return floor based on a stress test on the power generation project, wherein the stress tests determine the efficacy of risk mitigants for an operating condition risk, an equipment risk, and a residual value risk of the power generation project;
obtaining one or more contractual risk mitigants for the operating condition risk, the equipment risk, and the residual value risk;
providing a trustee or special purpose vehicle that manages revenues, fees, and proceeds from the one or more contractual risk mitigants with respect to the power generation project;
determining an amount of a fixed note payment associated with the power generation project, wherein the fixed note payment is guaranteed power sales energy revenue less scheduled operating expenses of the wind power generation project plus associated tax benefits;
obtaining, by an investor, an equity share of the power generation project based in part on paying the premium amount; and
obtaining revenues by the trustee or special purpose vehicle and paying an investor the fixed note payment, wherein the investor accounts for an investment of the premium amount in the power generation project as an equity linked note based on the premium amount and fixed note payment.

2. The method of claim 1, further comprising determining a variable note payment associated with the power generation project, wherein the variable note payment is residual power sales energy revenue plus any other benefits from operating the renewable power generation project.

3. The method of claim 1, wherein the power generation project is wind power and the contractual risk mitigant for the operating condition risk is wind insurance.

4. The method of claim 1, wherein the contractual risk mitigant for the residual value risk is a put option with acceptable collateral for the power generation project, the collateral being held by the trustee or special purpose vehicle.

5. The method of claim 1, wherein the contractual risk mitigant for the residual value risk is a residual value guaranty option with acceptable collateral for the power generation project, the collateral being held by the trustee or special purpose vehicle.

6. The method of claim 1, wherein contractual risk mitigants are obtained for the operating condition risk, the equipment risk, and the residual value risk, such that an overall risk of payment of the fixed payment note is substantially eliminated based on a combination of net revenue of the power generation project and proceeds from the contractual risk mitigants.

7. The method of claim 1, further comprising obtaining an unrelated service provider for the power generation project.

8. The method of claim 1, further comprising obtaining an unrelated asset manager for the power generation project, such that the investor retains owner/operator control of management of the power management project.

9. The method of claim 1, wherein the investor obtains operating debt funding for the power generation project based on the risk mitigants.

10. The method of claim 1, further comprising the investor obtaining additional funding based on a securitization of future capital contributions of the premium equal to a fixed percentage of the one or more contractual risk mitigation that protects the amount of the expected capital contribution.

11. The method of claim 1, wherein the investor purchases an energy generation facility.

12. The method of claim 1, wherein the investor provides one or more of a service contract, net lease, or inverted lease to a project management entity.

13. The method of claim 1, wherein the trustee or special purpose vehicle obtains the one or more contractual risk mitigants.
